(19) United States
(12) Patent Application Publication
(10) Pub. No.: US 2009/0303721 A1
(43) Pub. Date: Dec. 10, 2009

(54) Matrix LED street light gain structure

(76) Inventor: Hsu-Li Yen, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,569

(22) Filed: Jun. 6, 2008

(51) Int. Cl. F21V 21/00; F21V 29/02

(52) U.S. Cl. 362/249.11; 362/373

(57) ABSTRACT

A matrix LED street light gain structure, and more particularly, a matrix LED street light that serves the purposes of dissipating heat, saving energy, and increasing illumination area is provided. The matrix LED street light gain structure includes a metal lamp base. The metal lamp base includes a plurality of screw holes formed on an oblique surface of the metal lamp base and each adapted to be screwingly engaged with a matrix LED light strip. The oblique surface of the metal lamp base is a single oblique surface or a plurality of oblique surfaces for extending the reach of illumination of the matrix LED light strip. The metal lamp base further includes a plurality of spaced-apart heat-dissipating fins protrudingly formed on a rear surface of the metal lamp base.

### BACKGROUND OF THE INVENTION

1. Technical Field

The present invention relates to matrix LED street light structures, and more particularly, to a matrix LED street light gain structure.

2. Description of Related Art

Street lights are illumination facilities provided to assure traffic safety of pedestrians and vehicles at night or in low visibility conditions.

Street lighting commonly uses high pressure sodium lamps which incur high production costs, fail to be environment-friendly during a manufacturing process and when recycled, consume much power during operation and thereby fail to serve the purpose of energy saving.

Considering that the aforesaid drawbacks call for immediate solution, the inventor of the present invention continuously contemplated devising a street lighting device that meets environmental protection standards, serves the purpose of energy saving, and effectuates enhanced illumination. The inventor eventually came up with an environment-friendly, energy-saving, optimally illuminated matrix LED street light structure based on diligent research and repeated experiments.

The present invention is herein illustrated with a specific embodiment and the accompanying drawings, so that one skilled in the pertinent art can easily understand other objectives, advantages and effects of the present invention from the disclosure of the invention.

### BRIEF SUMMARY OF THE INVENTION

The present invention relates to a matrix LED street light gain structure, and more particularly, to a matrix LED street light that serves the purposes of dissipating heat, saving energy, and increasing illumination area. The matrix LED street light gain structure comprises a metal lamp base. The metal lamp base comprises a plurality of screw holes formed on an oblique surface of the metal lamp base and each adapted to be screwingly engaged with a matrix LED light strip. The oblique surface of the metal lamp base is a single oblique surface or a plurality of oblique surfaces for extending the reach of illumination of the matrix LED light strip. The metal lamp base further comprises a plurality of spaced-apart heat-dissipating fins protrudingly formed on a rear surface of the metal lamp base.

Heat generated by the illumination of the matrix LED light strip is transferred, via the metal lamp base, to the spaced-apart heat-dissipating fins on the rear surface of the metal lamp base. Air circulates in the space between the spaced-apart heat-dissipating fins, thereby enhancing heat dissipation.

### BRIEF DESCRIPTION OF THE SEVERAL VIEWS OF THE DRAWINGS

The structure and spirit of the present invention as well as a preferred mode of use, further objectives and advantages thereof will best be understood by reference to the following detailed description of an illustrative embodiment when read in conjunction with the accompanying drawings, wherein:

FIG. 1 is an exploded perspective view of a matrix LED street light gain structure according to the present invention;

FIG. 2 is a perspective view showing a metal lamp base of the matrix LED street light gain structure according to the present invention;

FIG. 3 is another perspective view showing the metal lamp base of the matrix LED street light gain structure according to the present invention; and

FIG. 4 is a perspective view of the matrix LED street light gain structure according to the present invention.

### DETAILED DESCRIPTION OF THE INVENTION

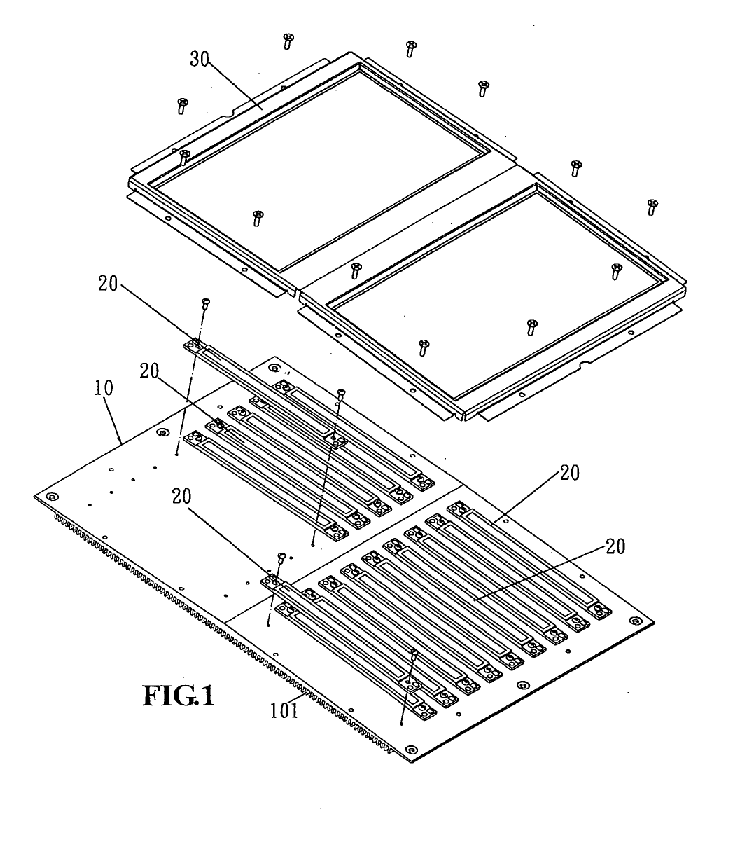

FIG. 1 is an exploded perspective view of a matrix LED street light gain structure according to the present invention. As shown in the drawing, the matrix LED street light gain structure comprises a metal lamp base 10 and a cover 30.

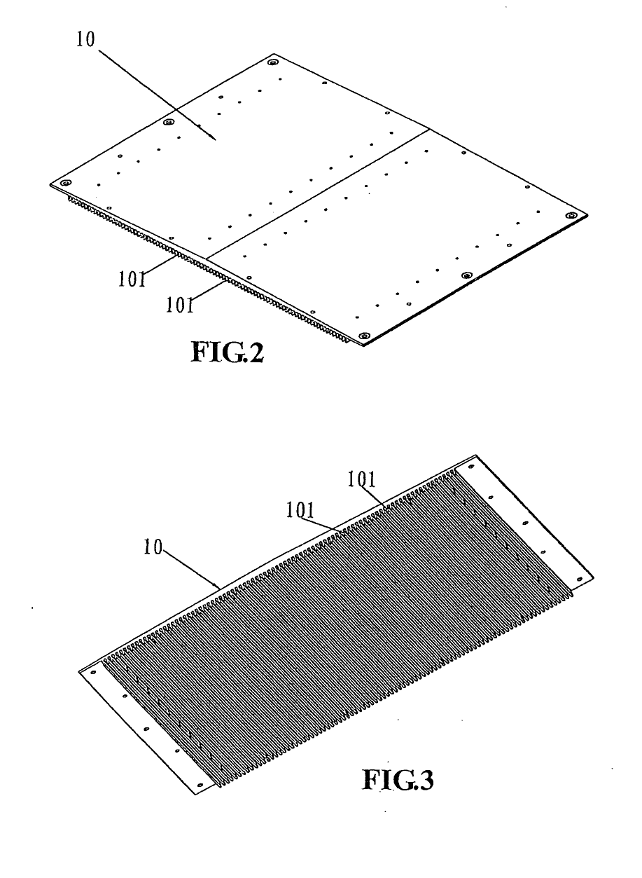

As further shown in FIGS. 2 and 3, the metal lamp base 10 has a plurality of screw holes formed on an oblique surface of the metal lamp base 10 and each adapted to be screwingly engaged with a matrix LED light strip 20. The oblique surface of the metal lamp base 10 is a single oblique surface or a plurality of oblique surfaces, so as to increase the range of illumination angles of the matrix LED light strip 20. The metal lamp base 10 has a plurality of spaced-apart heat-dissipating fins 101 protrudingly formed on a rear surface of the metal lamp base 10.

The cover 30 is adapted to be screwingly engaged with the metal lamp base 10.

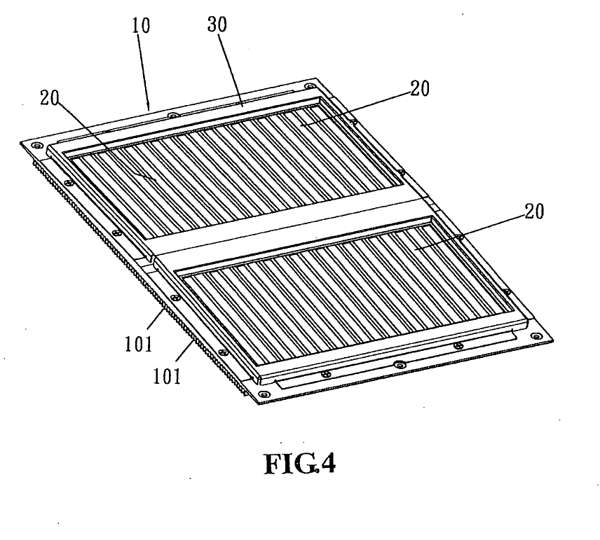

Referring to FIG. 4, the matrix LED light strip 20 is screwingly engaged with the screw holes of the metal lamp base 10, and the metal lamp base 10 is screwingly engaged with the cover 30, so as to form a matrix LED street light.

Referring to FIG. 1 again, the matrix LED light strip 20 is, in the form of multiple spaced-apart strips or in the form of a large single strip (not shown), screwingly fixed in position on the oblique surface of the metal lamp base 10.

Furthermore, heat generated by illumination of the matrix LED light strip 20 is transferred, via the metal lamp base 10, to the spaced-apart heat-dissipating fins 101 protrudingly formed on the rear surface of the metal lamp base 10. Air enters, circulates in, and exits the space between the spaced-apart heat-dissipating fins 101, thereby enhancing heat dissipation.

In conclusion, compared with a conventional street light, the matrix LED street light gain structure of the present invention is feasible, novel, non-obvious, and useful. Therefore, an application for patent of the present invention is hereby filed for examination.

The foregoing preferred embodiment is only illustrative of the features and functions of the present invention but is not intended to restrict the scope of the present invention. It is apparent to those skilled in the art that all equivalent modifications and variations made to the foregoing preferred embodiment according to the spirit and principle in the disclosure of the present invention should fall within the scope of the appended claims.

1. A matrix LED street light gain structure, comprising:
a metal lamp base having a plurality of screw holes formed on an oblique surface of the metal lamp base and each adapted to be screwingly engaged with a matrix LED light strip, the oblique surface being one of a single oblique surface and a plurality of oblique surfaces for increasing a range of illumination angles of the matrix LED light strip, and a plurality of spaced-apart heat-dissipating fins protrudingly formed on a rear surface of the metal lamp base; and
a cover adapted to be screwingly engaged with the metal lamp base;
wherein the matrix LED light strip is screwingly engaged with the screw holes of the metal lamp base, and the metal lamp base is screwingly engaged with the cover, so as to form a matrix LED street light.

2. The matrix LED street light gain structure of claim 1, wherein the oblique surface of the metal lamp base is a single oblique surface.

3. The matrix LED street light gain structure of claim 1, wherein the oblique surface of the metal lamp base is a plurality of oblique surfaces.

4. The matrix LED street light gain structure of claim 1, wherein the matrix LED light strip is, in the form of multiple spaced-apart strips, screwingly fixed in position on the oblique surface of the metal lamp base.

5. The matrix LED street light gain structure of claim 1, wherein the matrix LED light strip is, in the form of a large single strip, screwingly fixed in position on the oblique surface of the metal lamp base.
